(19) United States
(12) Patent Application Publication
(10) Pub. No.: US 2017/0229094 A1
(43) Pub. Date: Aug. 10, 2017

(54) DATA TRANSMISSION SYSTEM, DISPLAY DEVICE, AND METHOD OF TRANSMITTING DATA

(71) Applicant: Panasonic Liquid Crystal Display Co., Ltd., Hyogo (JP)

(72) Inventor: Kouji TAKAHASHI, Chiba (JP)

(21) Appl. No.: 15/018,852

(22) Filed: Feb. 8, 2016

(51) Int. Cl. G09G 5/00

(52) U.S. Cl. CPC G09G 5/006; G09G 2360/02

(57) ABSTRACT

Provided is a data transmission system, including: a source unit configured to send image data; a sink unit configured to receive the image data sent from the source unit; a first link training processing unit configured to perform first link training for setting a transmission condition of the image data to a transmission condition having a first level; an image data determination unit configured to determine whether or not an error is present in the image data sent in accordance with the first level transmission condition set by the first link training; and a second link training processing unit configured to perform, when an error in the image data has been detected, second link training for setting the transmission condition of the image data to a transmission condition having a second level that is different from the first level.

### BACKGROUND OF THE INVENTION

1. Field of the Invention

The present application relates to a data transmission system, a display device, and a method of transmitting data.

2. Description of the Related Art

Hitherto, as an interface configured to connect a source device configured to send image data and a display device (sink device) configured to receive and display the image data to each other, a DisplayPort (hereinafter referred to as “DP”) standard has been proposed. The DP standard has advantages such as increasing data transmission speed. Further, in recent years, an Embedded DisplayPort (hereinafter referred to as “eDP”) standard, which defines the DP standard as an internal interface, has been proposed (Japanese Patent No. 5799320).

In a source device and a display device that include a DP interface and an eDP interface and that are connected to each other via an interface conforming to the DP standard, processing (link training) for setting a condition (transmission condition) for transmitting image data from the source device to the display device is performed. In the link training, the above-mentioned transmission condition is set automatically, and hence a setting operation by a user is not necessary.

### SUMMARY OF THE INVENTION

The source device is configured to send, when the link training is complete, image data to the display device based on the above-mentioned transmission condition set by the link training. In this case, the quality of the image data sent from the source device may deteriorate due to the influence of the transmission line environment and the like. For example, an 8b/10b code error may occur in the image data based on the above-mentioned transmission condition set by the link training. Such image data may cause a deterioration in the display quality or prevent an image from being displayed. Further, in a related-art source device and display device, for example, there is a problem in that when the above-mentioned 8b/10b code error occurs in the image data, the transmission condition does not change even if link training is performed again, and as a result, the same error is repeated.

The present invention has been created in consideration of the above-mentioned problem. It is an object of the present invention to enable, in a source device and a display device connected to each other via a predetermined interface, the display device to properly perform image display even when an error has occurred in image data sent in accordance with a transmission condition set by link training.

In order to solve the above-mentioned problem, according to one embodiment of the present application, there is provided a data transmission system, including: a source unit configured to send image data; a sink unit configured to receive the image data sent from the source unit; a first link training processing unit configured to perform first link training for setting a transmission condition of the image data to a first level transmission condition having a first level; an image data determination unit configured to determine whether or not an error is present in the image data sent in accordance with the first level transmission condition set by the first link training; and a second link training processing unit configured to perform, when an error in the image data has been detected, second link training for setting the transmission condition of the image data to a second level transmission condition having a second level that is different from the first level.

In the data transmission system according to the one embodiment of the present application, the second level may be a level having a system margin ensured by the second link training that is larger than a system margin ensured by the first link training.

In the data transmission system according to the one embodiment of the present application: the data transmission system may further include: a source device including the source unit; and a sink device including the sink unit; the sink device may further include a display panel configured to display an image; and the sink device may be configured to display, when an error in the image data is not detected, an image on the display panel based on the image data sent in accordance with the first level transmission condition set by the first link training, and when an error in the image data has been detected, an image on the display panel based on the image data sent in accordance with the second level transmission condition set by the second link training.

In the data transmission system according to the one embodiment of the present application, the source unit and the sink unit may be connected to each other via an interface conforming to a DisplayPort (DP) standard.

In the data transmission system according to the one embodiment of the present application, the image data determination unit may be configured to detect whether or not an 8b/10b code error is present in the image data sent in accordance with the first level transmission condition set by the first link training.

Further, in order to solve the above-mentioned problem, according to one embodiment of the present application, there is provided a display device, including: a display panel configured to display an image; a sink unit configured to receive image data sent from a source device; a first link training processing unit configured to perform first link training for setting a transmission condition of the image data to a first level transmission condition having a first level; an image data determination unit configured to determine whether or not an error is present in the image data sent in accordance with the first level transmission condition set by the first link training; and a second link training processing unit configured to perform, when an error in the image data has been detected, second link training for setting the transmission condition of the image data to a second level transmission condition having a second level that is different from the first level, the display device being configured to display, when an error in the image data is not detected, an image on the display panel based on the image data sent in accordance with the first level transmission condition set by the first link training, and when an error in the image data has been detected, an image on the display panel based on the image data sent in accordance with the second level transmission condition set by the second link training.

Further, in order to solve the above-mentioned problem, according to one embodiment of the present application, there is provided a method of transmitting data to be executed by a computer, the method including: sending image data; receiving the sent image data; performing first link training for setting a transmission condition of the image data to a first level transmission condition having a first level; determining whether or not an error is present in the image data sent in accordance with the first level transmission condition set by the first link training; and performing, when an error in the image data has been detected, second link training for setting the transmission condition of the image data to a second level transmission condition having a second level that is different from the first level.

### BRIEF DESCRIPTION OF THE DRAWINGS

FIG. 1 is a block diagram for illustrating a functional configuration of a data transmission system according to an embodiment of the present application.

FIG. 2 is a flowchart for illustrating operation of data transmission processing in the data transmission system according to the embodiment of the present application.

### DETAILED DESCRIPTION OF THE INVENTION

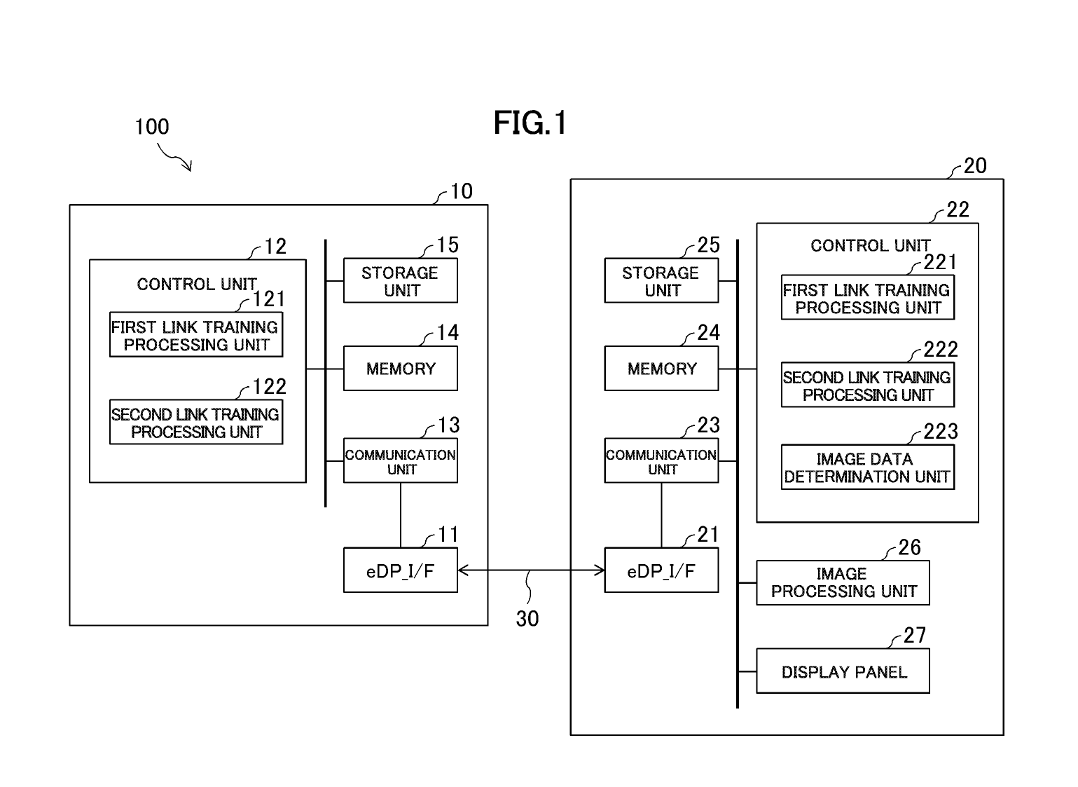

An embodiment of the present application is now described with reference to the drawings. FIG. 1 is a block diagram for illustrating a functional configuration of a data transmission system according to the embodiment of the present application. A data transmission system 100 according to this embodiment includes a source device 10 configured to send image data and a display device 20 (sink device) configured to receive the image data and display an image. The source device 10 and the display device 20 are connected to each other via a predetermined interface conforming to the DP standard. An eDP interface (eDP_I/F) is now described as an example of the above-mentioned interface.

The source device 10 includes an eDP_I/F 11, a control unit 12, a communication unit 13, a memory 14, and a storage unit 15. Each of the hardware elements configuring the source device 10 are connected to each other by a bus in a manner that enables data to be sent and received to and from each hardware element. The eDP_I/F includes a connector conforming to the DP standard. The communication unit 13 is configured to send and receive various types of data via the eDP_I/F 11. For example, the communication unit 13 is configured to send image data to the display device 20 via the eDP_I/F 11. In other words, the communication unit 13 and the eDP_I/F 11 have a function as a source unit configured to send image data to the display device 20. The control unit 12 is configured to control each unit of the source device 10, and perform various types of information processing. The control unit 12 may be configured by, for example, a central processing unit (CPU). The memory 14 is configured to hold various types of programs and data. Further, in the memory 14, a work area for the control unit 12 is also secured. The storage unit 15 is configured to store various types of data, including image data.

The control unit 12 includes a first link training processing unit 121 and a second link training processing unit 122. The first link training processing unit 121 is configured to, by controlling the communication unit 13, perform link training in accordance with an eDP protocol (first link training), establish (link up) a transmission path to the display device 20, and prepare the image data to be in a state ready to be sent or received. The control unit 12 is configured to convert, after a link-up has been established, the image data to be sent to the display device 20 into image data in a data format conforming to the eDP standard, and output the converted image data to the communication unit 13. The communication unit 13 is configured to send the image data input from the control unit 12 to the display device 20 from the eDP_I/F 11 via a transmission line 30 in accordance with the eDP protocol. The second link training processing unit 122 is configured to perform, when an error has occurred in the image data sent to the display device 20 after the link-up had been established in the first link training, link training (second link training) for setting to a transmission condition having a level different from the level of the transmission condition set by the first link training. The specific details of the first link training and the second link training are described later. Note that, the control unit 12 may also include a data conversion unit configured to convert serial data and parallel data to and from each other, and an 8b/10b encoder configured to convert 8-bit data into 10-bit data.

The display device 20 includes an eDP_I/F 21, a control unit 22, a communication unit 23, a memory 24, a storage unit 25, an image processing unit 26, and a display panel 27.

Similarly to the eDP_I/F 11, the eDP_I/F 21 includes a connector conforming to the DP standard. The communication unit 23 is configured to send and receive various types of data via the eDP_I/F 21. For example, the communication unit 23 is configured to receive image data from the source device 10 via the eDP_I/F 21. In other words, the communication unit 23 and the eDP_I/F 21 have a function as a sink unit configured to receive image data. The control unit 22 is configured to control each unit of the display device 20, and perform various types of information processing. The control unit 22 may be configured by, for example, a CPU. The memory 24 is configured to hold various types of programs and data. Further, in the memory 24, a work area for the control unit 22 is also secured. The storage unit 25 is configured to store various types of data, including image data. The image processing unit 26 is configured to perform various types of image processing on the image data received from the source device 10, and output the processed image data to the display panel 27. The image processing may include known processing, such as tone correction. As the display panel 27, various types of panels may be employed, such as a liquid crystal panel and an organic electroluminescent (EL) panel.

The control unit 22 includes a first link training processing unit 221, a second link training processing unit 222, and an image data determination unit 223. The first link training processing unit 221 is configured to, by controlling the communication unit 23, perform link training based on the eDP protocol (first link training), establish (link up) a transmission path to the source device 10, and prepare the image data to be in a state ready to be sent or received. The image data determination unit 223 is configured to determine whether or not an error has occurred in the image data received from the source device 10 after the link-up has been established by the first link training. The second link training processing unit 222 is configured to perform, when an error has been detected in the image data, second link training for setting to a transmission condition having a level different from the level of the transmission condition set by the first link training. The specific details of the first link training and the second link training are described later. Note that, the control unit 22 may also include a data conversion unit configured to convert serial data and parallel data to and from each other, and an 8b/10b decoder configured to convert 10-bit data into 8-bit data. The data bit conversion method is not limited. Further, the control unit 22 also has a function as a common timing controller.

In the data transmission system 100 configured as described above, the elements included in the control units 12 and 22 are realized by the CPU executing programs stored in the memories 14 and 24. The programs may be installed in the source device 10 and the display device 20 from a computer-readable information processing medium, such as a compact-disc read-only memory (CD-ROM), a digital versatile disc (DVD) ROM, and a memory card, or may be downloaded to the source device 10 and the display device 20 from a communication network, such as the Internet.

The eDP_I/Fs 11 and 21 each include a Hot Plug Detect (HPD) channel configured to detect a connection to another device, an auxiliary (AUX) channel configured to transmit control data (commands) for link training and the like, and a main link configured to transmit data, such as image data. The main link is set to four lanes, for example. The transmission line 30 includes an HPD line configured to transmit an HPD signal, an AUX line, and a main link line. The HPD signal is a signal indicating whether or not the display device 20 permits the source device 10 to acquire device information on the display device 20. The device information on the display device 20 is, for example, Extended Display Identification Data (EDID). The EDID of the display device 20 includes, for example, various types of information, such as identification information and capability information on the display device 20.

Next, operation of data transmission processing including link training in the data transmission system 100 is described. The link training performed in the data transmission system 100 according to this embodiment includes first link training and second link training. Examples of the transmission condition to be set by the link training may include an amplitude level (swing level) of an output voltage, a pre-emphasis level, and the like. In the second link training, the transmission condition is set to a higher level (second level) than the level of the transmission condition (first level) set by the first link training. For example, the second level is a level in which a system margin ensured by the second link training is larger than the system margin ensured by the first link training. The first link training is performed based on a collaborative operation by the first link training processing units 121 and 221, and the second link training is performed based on a collaborative operation by the second link training processing units 122 and 222.

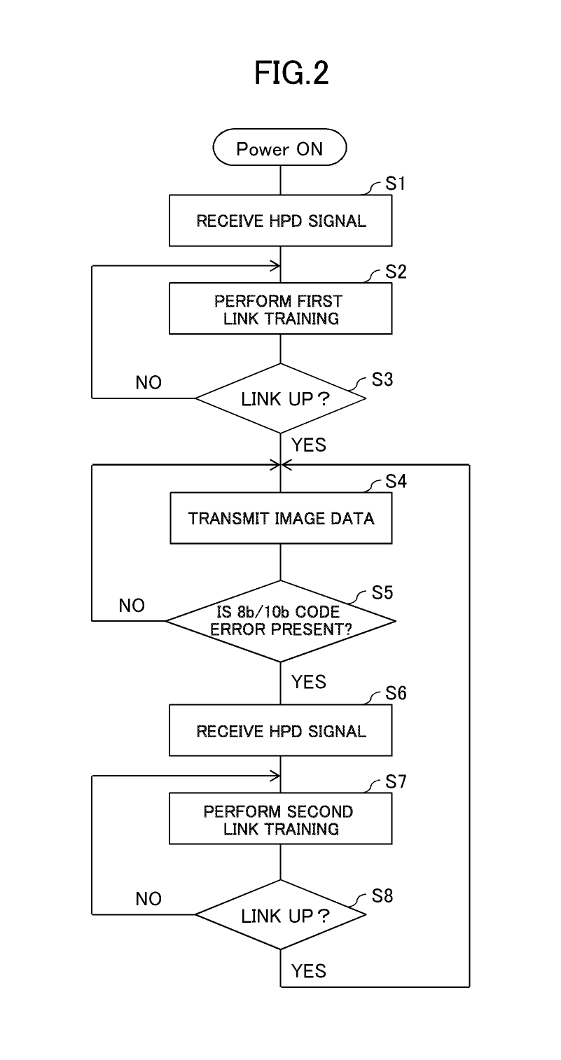

FIG. 2 is a flowchart for illustrating operation of data transmission processing in the data transmission system 100. The operation of data transmission processing is now described with reference to FIG. 2.

First, when the power of the data transmission system 100 has been turned ON and the display device 20 is in an operable state, the source device 10 receives an HPD signal from the display device 20 (S1). For example, when the source device 10 and the display device 20 have been connected to each other via the transmission line 30, the control unit 22 of the display device 20 detects the connection to the source device 10, and the control unit 12 of the source device 10 detects the connection to the display device 20.

Next, the first link training processing units 121 and 221 perform the first link training (S2). In the first link training, the source device 10 and the display device 20 determine the number of lanes to be used to transmit image data, a data transfer rate of each lane, and the like, by sending and receiving data such as EDID and DisplayPort Configuration Data (DPCD). DPCD includes setting values relating to a resolution of the image data capable of being received by the display device 20, a transmission path capacity, and the like.

For example, the first link training processing unit 121 sends an EDID read request to the display device 20. The first link training processing unit 221 receives the EDID read request, and based on the request, sends the EDID to the source device 10. The first link training processing unit 121 acquires the EDID, and then sends a DPCD read request based on a link connection request to the display device 20. The first link training processing unit 221 receives the DPCD read request, and based on the request, sends the DPCD to the source device 10.

The first link training processing unit 121 performs processing for determining the transmission condition corresponding to the first level, which includes the number of lanes to be used and the data transfer rate, based on the EDID and the DPCD acquired from the display device 20, and confirming whether or not data can be transmitted based on the transmission condition. In other words, the first link training processing unit 121 sends the first level transmission condition and a packet for confirming the communication state to the first link training processing unit 221. The first link training processing units 121 and 221 attempt a communication test based on the confirmation packet. The first link training processing unit 221 establishes a connection by acquiring the result of the communication test and the transmission condition, and moves to a state in which the display device 20 can receive the image data.

The first link training processing unit 121 establishes a connection by acquiring the result of the communication test, and then moves to a state in which the source device 10 can send the image data. When the first link training processing units 121 and 221 cannot properly link up based on the above-mentioned communication test, the first link training processing units 121 and 221 change the transmission condition and perform the first link training again (S3). The first link training is performed a predetermined number of times until a link-up is successfully established. When the first link training finishes normally and a link-up is established, the control unit 12 starts transmission of the image data (S4). Thus, when the transmission condition between the source device 10 and the display device 20 is set by determining the transmission condition that is based on the first level by the first link training, the image data is transmitted in accordance with the transmission condition that is based on the first level. The above-mentioned first link training processing is an example, and another known method may also be employed.

The data transmission processing by the data transmission system 100 according to this embodiment has a function for performing second link training when an error has occurred in the image data sent in accordance with the above-mentioned transmission condition set by the first link training. The processing of the second link training is now described.

When a link-up is established between the source device 10 and the display device 20 by the first link training, and transmission of the image data starts (S4), the image data determination unit 223 of the display device 20 detects whether or not an error is present in the image data input to the display device 20 (S5). The error in the image data is, for example, an error that causes a deterioration in the quality of the image data due to the influence of the environment of the transmission line 30 to cause a deterioration in the display quality or prevent the image from being displayed. A specific example of the error is an 8b/10b code error. In this case, as an example, the image data determination unit 223 detects whether or not an 8b/10b code error has occurred in the image data. For example, the image data determination unit 223 detects whether or not an 8b/10b code error is present in the image data by determining whether or not an error count per lane exceeds a predetermined threshold.

When an 8b/10b code error has occurred in the image data, first, the source device 10 receives an HPD signal from the display device 20 (S6). Next, the second link training processing units 122 and 222 perform the second link training (S7). In the second link training, the image data transmission condition is set to a higher level (second level) than the level of the transmission condition (first level) in the first link training.

In the first link training and the second link training, the transmission condition level is different, but the remaining processing may be the same. Specifically, the second link training processing unit 122 sends an EDID read request to the display device 20. The second link training processing unit 222 receives the EDID read request, and based on the request, sends the EDID to the source device 10. The second link training processing unit 122 acquires the EDID, and then sends a DPCD read request based on a link connection request to the display device 20. The second link training processing unit 222 receives the DPCD read request, and based on the request, sends the DPCD to the source device 10.

The second link training processing unit 122 performs processing for determining the transmission condition corresponding to the second level, which includes the number of lanes to be used and the data transfer rate, based on the EDID and the DPCD acquired from the display device 20, and confirming whether or not data can be transmitted based on the transmission condition. In other words, the second link training processing unit 122 sends the second level transmission condition and a packet for confirming the communication state to the second link training processing unit 222. The second link training processing units 122 and 222 attempt a communication test based on the confirmation packet. The second link training processing unit 222 establishes a connection by acquiring the result of the communication test and the transmission condition, and moves to a state in which the display device 20 can receive the image data.

The second link training processing unit 122 establishes a connection by acquiring the result of the communication test, and then moves to a state in which the source device 10 can send the image data. When the second link training processing units 122 and 222 cannot properly link up based on the above-mentioned communication test, the second link training processing units 122 and 222 change the transmission condition and perform the second link training again (S8). The second link training is performed a predetermined number of times until a link-up is successfully established. When the second link training finishes normally and a link-up is established, the control unit 12 restarts transmission of the image data (S4). Thus, when the transmission condition between the source device 10 and the display device 20 is set by determining the transmission condition that is based on the second level by the second link training, the image data is transmitted in accordance with the transmission condition that is based on the second level.

Thus, the data transmission system 100 is configured to display, when an error in the image data is not detected, an image based on the image data sent in accordance with the first level transmission condition set by the first link training, and when an error in the image data has been detected, an image based on the image data sent in accordance with the second level transmission condition set by the second link training.

In the above-mentioned data transmission processing, the system margin ensured by the second link training is larger than the system margin ensured by the first link training. Therefore, even when an error has occurred in the image data sent in accordance with the transmission condition set by the first link training, the image data can be properly transmitted. As a result, the display device 20 can perform image display properly.

The second link training processing is not limited to the processing described above. For example, the image data determination unit 223 may be configured to send, when having detected an 8b/10b code error in the image data, the detection result to the display device 20. In this case, the control unit 12 of the source device 10 is configured to send, based on the detection result, the image data to the display device 20 in accordance with the second level transmission condition. When the display device 20 receives the image data from the source device 10, the second link training processing units 122 and 222 perform the second link training. Thus, in the data transmission system 100, when an error has occurred in the image data sent in accordance with the first level transmission condition set by the first link training, the display device 20 may perform the second link training by issuing a request to the source device 10 for the second level transmission condition, or the source device 10 may change the image data transmission condition to the second level before performing the second link training.

The first level transmission condition and the second level transmission condition may be stored in advance in the storage units 15 and 25, or the first level transmission condition and the second level transmission condition may be in a format that allows those conditions to be changed by the user. Further, the number of transmission conditions stored in the storage units 15 and 25 is not limited, and three or more transmission conditions of different levels may be stored. In addition, when a link-up has been established by the second link training, the second level may be set to an initial value. In other words, the transmission condition level in the first link training (first level) may be updated to the second level.

The second link training processing may also be performed by changing only one of the source device 10 and the display device 20 (sink device) from the operation defined in the related art. For example, when the second link training is performed by changing only the sink device from the currently defined operation, in the second link training, a request may be issued to the source device via DPCD for a level that is one or more levels higher than the level at which a packet for communication testing was successfully detected during the setting process of the swing level and the pre-emphasis level. In this case, at the initial stage when the packet for communication testing has been successfully detected, a message indicating that detection has been successful is not transmitted to the source device via DPCD. Further, for example, when the second link training is performed by changing only the source device from the currently defined operation, in the second link training after an interrupt to the HPD signal has been detected, during the setting process of the swing level and the pre-emphasis level, the transmission condition may be set to a transmission condition having a larger system margin by starting from a level that is one or more levels higher than the stored transmission condition level set by the first link training.

While there have been described what are at present considered to be certain embodiments of the application, it will be understood that various modifications may be made thereto, and it is intended that the appended claims coverall such modifications as fall within the true spirit and scope of the invention.

What is claimed is:

1. A data transmission system, comprising:
a source unit configured to send image data;
a sink unit configured to receive the image data sent from the source unit;
a first link training processing unit configured to perform first link training for setting a transmission condition of the image data to a first level transmission condition having a first level;
an image data determination unit configured to determine whether or not an error is present in the image data sent in accordance with the first level transmission condition set by the first link training; and
a second link training processing unit configured to perform, when an error in the image data has been detected, second link training for setting the transmission condition of the image data to a second level transmission condition having a second level that is different from the first level.

2. The data transmission system according to claim 1, wherein the second level comprises a level having a system margin ensured by the second link training that is larger than a system margin ensured by the first link training.

3. The data transmission system according to claim 1, further comprising:
a source device comprising the source unit; and
a sink device comprising the sink unit,
wherein the sink device further comprises a display panel configured to display an image, and
wherein the sink device is configured to display, when an error in the image data is not detected, an image on the display panel based on the image data sent in accordance with the first level transmission condition set by the first link training, and when an error in the image data has been detected, an image on the display panel based on the image data sent in accordance with the second level transmission condition set by the second link training.

4. The data transmission system according to claim 1, wherein the source unit and the sink unit are connected to each other via an interface conforming to a DisplayPort (DP) standard.

5. The data transmission system according to claim 1, wherein the image data determination unit is configured to detect whether or not an 8b/10b code error is present in the image data sent in accordance with the first level transmission condition set by the first link training.

6. A display device, comprising:
a display panel configured to display an image;
a sink unit configured to receive image data sent from a source device;
a first link training processing unit configured to perform first link training for setting a transmission condition of the image data to a first level transmission condition having a first level;
an image data determination unit configured to determine whether or not an error is present in the image data sent in accordance with the first level transmission condition set by the first link training; and
a second link training processing unit configured to perform, when an error in the image data has been detected, second link training for setting the transmission condition of the image data to a second level transmission condition having a second level that is different from the first level,
the display device being configured to display, when an error in the image data is not detected, an image on the display panel based on the image data sent in accordance with the first level transmission condition set by the first link training, and when an error in the image data has been detected, an image on the display panel based on the image data sent in accordance with the second level transmission condition set by the second link training.

7. A method of transmitting data to be executed by a computer, the method comprising:
sending image data;
receiving the sent image data;
performing first link training for setting a transmission condition of the image data to a first level transmission condition having a first level;
determining whether or not an error is present in the image data sent in accordance with the first level transmission condition set by the first link training; and
performing, when an error in the image data has been detected, second link training for setting the transmission condition of the image data to a second level transmission condition having a second level that is different from the first level.
